(19) United States
(12) Patent Application Publication
(10) Pub. No.: US 2019/0306774 A1
(43) Pub. Date: Oct. 3, 2019

(54) Wireless Local Area Network Access Point Handover Method and Terminal

(71) Applicant: Huawei Technologies Co., Ltd., Shenzhen (CN)

(72) Inventors: Shuanglin Cai, Xi'an (CN); Lihu Qu, Xi'an (CN); Jun Xu, Shenzhen (CN); Tongming Hu, Xi'an (CN); Anchao He, Xi'an (CN); Jingwei Qu, Xi'an (CN); Yongtao Wu, Wuhan (CN)

(21) Appl. No.: 16/465,676

(22) PCT Filed: Mar. 24, 2017
(86) PCT No.: PCT/CN2017/078006

§ 371 Date: May 31, 2019

(30) Foreign Application Priority Data
Dec. 1, 2016 (CN) 201611091353.2

(51) Int. Cl. H04W 36/30; H04W 36/08

(52) U.S. Cl. CPC H04W 36/30; H04W 84/12; H04W 36/08

(57) ABSTRACT

A method includes: establishing, by a terminal, a first communication connection to a first access point by using a first workstation; determining, by the terminal, that signal quality of the first access point meets a handover condition, detecting, by the terminal, a second access point, and establishing, by the terminal, a second communication connection to the second access point by using a second workstation; and determining, by the terminal, that signal quality of the second access point is better than the signal quality of the first access point, and breaking, by the terminal, the first communication connection.

### CROSS-REFERENCE TO RELATED APPLICATIONS

This application is a national stage of International Application No. PCT/CN2017/078006, filed on Mar. 24, 2017, which claims priority to Chinese Patent Application No. 201611091353.2, filed on Dec. 1, 2016. Both of the aforementioned applications are hereby incorporated by reference in their entireties.

### TECHNICAL FIELD

The present invention relates to the field of communications technologies, and in particular, to a wireless local area network access point handover method and a terminal.

### BACKGROUND

Continuous development of mobile networks makes surfing on mobile Internet extremely popular. As a technology that allows an electronic device to connect to a wireless local area network (Wireless Local Area Network, WLAN), Wireless Fidelity (Wireless Fidelity, Wi-Fi) is favored by a growing quantity of users because of advantages such as a fast transmission speed and low costs. In addition, a growing quantity of Wi-Fi wireless local area network access points (Access Point, AP), namely, Wi-Fi APs, are distributed in public places such as a coffee shop, a large office, a grand shopping mall, a stadium, and a subway station. Because a Wi-Fi AP has a limited coverage area, a terminal needs to be handed over between a plurality of Wi-Fi APs in a moving process. The terminal includes a device with a Wi-Fi function, such as a mobile phone, a router, or a mobile Wi-Fi device.

In the prior art, when moving between coverage areas of different Wi-Fi APs, the terminal needs to be first disconnected from a current Wi-Fi AP and then connected to another Wi-Fi AP. During this period, a data service of the terminal is inevitably interrupted for a few seconds or even dozens of seconds. An interruption of the data service deteriorates user experience especially when the terminal relies on a Wi-Fi network. For example, a terminal is located in a place with a poor signal, such as a home distributed Wi-Fi network environment, a subway station, or an underground parking area.

### SUMMARY

Embodiments of the present invention provide a wireless local area network access point handover method and a terminal, to resolve a data service interruption problem in a wireless local area network access point handover process.

According to a first aspect, the present invention provides a wireless local area network access point handover method. A terminal establishes a first communication connection to a first access point by using a first workstation. The terminal determines that signal quality of the first access point meets a handover condition, the terminal detects a second access point, and the terminal establishes a second communication connection to the second access point by using a second workstation. The terminal determines that signal quality of the second access point is better than the signal quality of the first access point, and the terminal breaks the first communication connection.

In this embodiment of the present invention, when maintaining a connection between the first workstation and a current access point, the terminal establishes a connection to another access point by using the second workstation. After determining that signal quality of the another access point is better than signal quality of the current access point, the terminal breaks the connection between the first workstation and the current access point, and retains the connection between the second workstation and the another access point, thereby implementing a seamless handover between the terminal and an access point, and improving user experience.

In a possible implementation, before the terminal establishes the second communication connection to the second access point by using the second workstation, the method further includes: generating, by the terminal, the second workstation. According to this implementation, when maintaining the connection between the first workstation and the current access point, the terminal may establish the connection to the another connection point by generating the second workstation.

In a possible implementation, the first workstation works at a first physical layer, and the second workstation works at a second physical layer.

In a possible implementation, the terminal includes a first Wireless Fidelity Wi-Fi chip, and the first Wi-Fi chip is configured to generate the first workstation and the second workstation.

In a possible implementation, the terminal includes a first Wireless Fidelity Wi-Fi chip and a second Wi-Fi chip, the first Wi-Fi chip is configured to generate the first workstation, and the second Wi-Fi chip is configured to generate the second workstation.

In a possible implementation, that the terminal determines that signal quality of the first access point meets a handover condition includes: performing, by the terminal, link detection on the first communication connection, and determining, based on a result of the link detection, that the signal quality of the first access point meets the handover condition.

In a possible implementation, that the terminal determines that signal quality of the second access point is better than the signal quality of the first access point includes: performing, by the terminal, link detection on the second communication connection, and determining, based on a result of the link detection, that the signal quality of the second access point is better than the signal quality of the first access point.

In a possible implementation, a parameter of the link detection includes received signal strength, a packet error rate, and a data transmission delay.

According to a second aspect, an embodiment of the present invention provides a terminal, the terminal may implement a function performed by the terminal in the wireless local area network access point handover method in the first aspect, and the function may be implemented by using hardware, or may be implemented by hardware executing corresponding software. The hardware or software includes one or more modules corresponding to the function.

In a possible design, the terminal includes a communications module and a processing module. The processing module is configured to: control the communications module to establish a first communication connection to a first access point by using a first workstation; determine that signal quality of the first access point meets a handover condition, detect a second access point, and control the communications module to establish a second communication connection to the second access point by using a second workstation; and determine that signal quality of the second access point is better than the signal quality of the first access point, and control the communications module to break the first communication connection.

In a possible design, the processing module is further configured to generate the second workstation before controlling the communications module to establish the second communication connection to the second access point by using the second workstation.

In a possible design, the first workstation works at a first physical layer, and the second workstation works at a second physical layer.

In a possible design, the terminal includes a first Wireless Fidelity Wi-Fi chip, and the first Wi-Fi chip is configured to generate the first workstation and the second workstation.

In a possible design, the terminal includes a first Wireless Fidelity Wi-Fi chip and a second Wi-Fi chip, the first Wi-Fi chip is configured to generate the first workstation, and the second Wi-Fi chip is configured to generate the second workstation.

In a possible design, that the processing module determines that signal quality of the first access point meets a handover condition includes: performing, by the processing module, link detection on the first communication connection, and determining, based on a result of the link detection, that the signal quality of the first access point meets the handover condition.

In a possible design, that the processing module determines that signal quality of the second access point is better than the signal quality of the first access point includes: performing, by the processing module, link detection on the second communication connection, and determining, based on a result of the link detection, that the signal quality of the second access point is better than the signal quality of the first access point.

In a possible design, a parameter of the link detection includes received signal strength, a packet error rate, and a data transmission delay.

According to a third aspect, an embodiment of the present invention provides a terminal, and the terminal may implement a function performed by the terminal in the wireless local area network access point handover method in the first aspect.

In a possible design, the terminal includes a processor, a memory, and a wireless local area network WLAN module. The memory is configured to store a program instruction. The processor is configured to perform, based on the program instruction stored in the memory, the following operations: instructing the WLAN module to establish a first communication connection to a first access point by using a first workstation; determining that signal quality of the first access point meets a handover condition, instructing the WLAN module to detect a second access point, and instructing the WLAN module to establish a second communication connection to the second access point by using a second workstation; and determining that signal quality of the second access point is better than the signal quality of the first access point, and instructing the WLAN module to break the first communication connection.

In a possible design, the processor is further configured to perform, based on the program instruction stored in the memory, the following operation: before instructing the WLAN module to establish the second communication connection to the second access point by using the second workstation, instructing the WLAN module to generate the second workstation.

In a possible design, the first workstation works at a first physical layer, and the second workstation works at a second physical layer.

In a possible design, the WLAN module includes a first Wireless Fidelity Wi-Fi chip, and the first Wi-Fi chip is configured to generate the first workstation and the second workstation.

In a possible design, the WLAN module includes a first Wi-Fi chip and a second Wi-Fi chip, the first Wi-Fi chip is configured to generate the first workstation, and the second Wi-Fi chip is configured to generate the second workstation.

In a possible design, the processor is specifically configured to perform, based on the program instruction stored in the memory, the following operations: instructing the WLAN module to perform link detection on the first communication connection, and determining, based on a result of the link detection, that the signal quality of the first access point meets the handover condition.

In a possible design, the processor is specifically configured to perform, based on the program instruction stored in the memory, the following operations: instructing the WLAN module to perform link detection on the second communication connection, and determining, based on a result of the link detection, that the signal quality of the second access point is better than the signal quality of the first access point.

In a possible design, a parameter of the link detection includes received signal strength, a packet error rate, and a data transmission delay.

According to the wireless local area network access point handover method and the terminal provided in the embodiments of the present invention, when maintaining a connection between the first workstation and a current access point, the terminal establishes a connection to another access point by using the second workstation. After determining that signal quality of the another access point is better than signal quality of the current access point, the terminal breaks the connection between the first workstation and the current access point, and retains the connection between the second workstation and the another access point, thereby implementing a seamless handover between the terminal and an access point, and improving user experience.

### BRIEF DESCRIPTION OF THE DRAWINGS

FIG. 1 is a schematic architectural diagram of a communications system according to an embodiment of the present invention;

FIG. 2 is a schematic diagram of communication in a wireless local area network access point handover method according to an embodiment of the present invention;

FIG. 3 is a schematic diagram of communication in another wireless local area network access point handover method according to an embodiment of the present invention;

FIG. 4 is a schematic diagram of an access point handover application scenario of a terminal according to an embodiment of the present invention;

FIG. 5 is a schematic structural diagram of a terminal according to an embodiment of the present invention; and

FIG. 6 is a schematic structural diagram of another terminal according to an embodiment of the present invention.

### DETAILED DESCRIPTION OF ILLUSTRATIVE EMBODIMENTS

The following describes the technical solutions in the embodiments of the present invention with reference to the accompanying drawings in the embodiments of the present invention.

Network architectures and service scenarios that are described in the embodiments of the present invention are used to describe the technical solutions in the embodiments of the present invention more clearly, but are not intended to limit the technical solutions provided in the embodiments of the present invention. A person of ordinary skill in the art may learn that, with evolution of the network architectures and emergence of a new service scenario, the technical solutions provided in the embodiments of the present invention are also applicable to a similar technical problem.

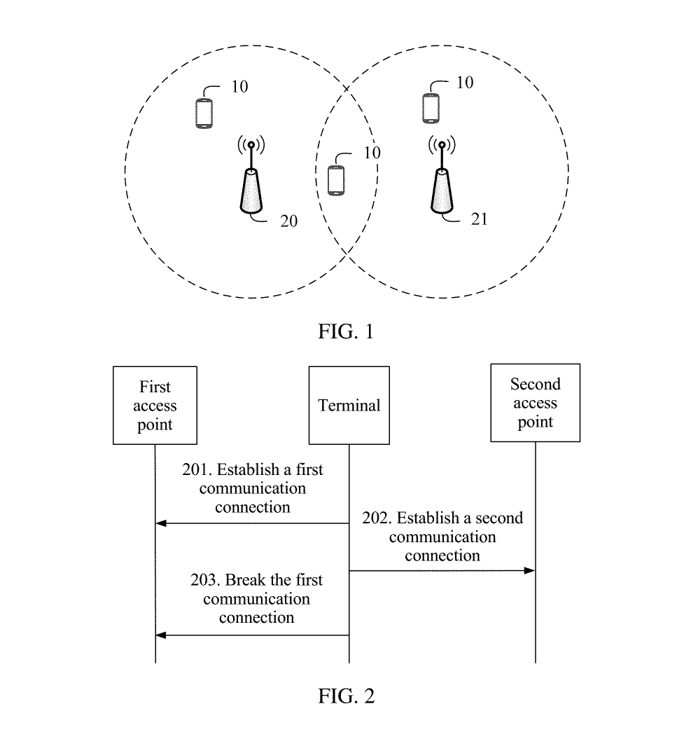

FIG. 1 is a schematic architectural diagram of a communications system according to an embodiment of the present invention. As shown in FIG. 1, the communications system includes at least one terminal 10 and at least two wireless local area network access points 20 and 21. The figure shows only one terminal and two access points, but there may be more terminals and more access points in practice. This is not limited in this embodiment of the present invention.

In this embodiment of the present invention, the wireless local area network access point may be a Wi-Fi AP, or may be an AP that supports another wireless access technology. All access points with which the terminal can access a network by using a wireless access technology fall within the protection scope of the embodiments of the present invention, and details are not described herein.

In this embodiment of the present invention, the terminal may be a device such as a mobile phone or a computer having a Wi-Fi function, or a device supporting another wireless access technology. All devices that can connect to a wireless local area network access point fall within the protection scope of the embodiments of the present invention, and details are not described herein.

According to a wireless local area network access point handover method provided in an embodiment of the present invention, when maintaining a connection between a first workstation and a current access point, the terminal establishes a connection to another access point by using a second workstation. After determining that signal quality of the another access point is better than signal quality of the current access point, the terminal breaks the connection between the first workstation and the current access point, and retains the connection between the second workstation and the another access point, thereby implementing a seamless handover between the terminal and an access point, and improving user experience.

FIG. 2 is a schematic diagram of communication in a wireless local area network access point handover method according to an embodiment of the present invention. As shown in FIG. 2, this embodiment may include the following steps.

Step 201: A terminal establishes a first communication connection to a first access point by using a first workstation.

For example, the first access point is a wireless local area network access point, for example, a Wi-Fi AP.

For example, the first communication connection is a radio link connection. A process of establishing the radio link connection includes: performing link authentication between a workstation and an access point, and negotiating a radio link service parameter.

Step 202: The terminal determines that signal quality of the first access point meets a handover condition, the terminal detects a second access point, and the terminal establishes a second communication connection to the second access point by using a second workstation.

For example, that the terminal determines that signal quality of the first access point meets a handover condition includes: performing, by the terminal, link detection on the first communication connection, and determining, based on a result of the link detection, that the signal quality of the first access point meets the handover condition.

For example, the terminal periodically performs link detection on the first communication connection. For example, a detection period is set, and link detection is performed in every detection period.

For example, a parameter of the link detection may include received signal strength, a packet error rate, and a data transmission delay.

For example, the handover condition may be a comprehensive determining criterion. For example, the received signal strength is less than −78 dBm, the packet error rate is greater than 5%, and the data transmission delay is greater than one second.

For example, a comprehensive score is made on the result, namely, parameter values of the link detection based on a comprehensive algorithm for the parameters of the link detection, and a preset threshold is set. The handover condition may be that the comprehensive score is greater than the preset threshold. In the comprehensive algorithm, different weights may be assigned to the parameters such as the received signal strength, the packet error rate, and the data transmission delay, and scores are made based on the parameter values. For example, a parameter value corresponding to the received signal strength is −60 dBm. Because −60 dBm is greater than −78 dBm, and this does not meet the condition that the received signal strength is less than −78 dBm, a score of the parameter value is 0. A parameter value corresponding to the packet error rate is 6%. Because 6% is greater than 5%, and this meets the condition that the packet error rate is greater than 5%, a score of the parameter value is 4. A parameter value corresponding to the data transmission delay is 1.5 seconds. Because 1.5 seconds are greater than one second, and this meets the condition that the data transmission delay is greater than one second, a score of the parameter value is 3. As shown in Table 1, different weights are assigned to different parameters. Calculation is made based on Table 1 to obtain a comprehensive score 2.4 of this group of parameters, and a value of the preset threshold is set to 2.1. Because the comprehensive score 2.4 is greater than the preset threshold 2.1, the handover condition is met.

TABLE 1

| | Received | | |
|---|---|---|---|
| Parameter | signal strength | Packet error rate | Data transmission delay |
| Weight | 0.3 | 0.3 | 0.4 |

A physical layer (Physical Layer) is a lowest layer of an Open Systems Interconnection reference model (Open Systems Interconnection reference model, OSI/RM). The physical layer specifies that mechanical, electrical, functional, and procedural characteristics are provided to create, maintain, and delete a physical link required for data transmission. The physical layer provides a transmission medium and an interconnection device for data communication between devices, and provides a reliable environment for data transmission. Usually, in practice, one terminal includes one Wi-Fi chip, and one Wi-Fi chip includes one physical layer. Alternatively, one terminal may include two Wi-Fi chips or one Wi-Fi chip may include two physical layers. The two Wi-Fi chips or physical layers may provide concurrency of a 2.4G frequency band and a 5G frequency band. For example, a use may simultaneously use the 2.4G frequency band and the 5G frequency band on a terminal. The 2.4G frequency band and the 5G frequency band are two common radio frequency bands at the physical layer. The Wi-Fi chip may further support another frequency band in this embodiment of the present invention. This is not limited in this embodiment of the present invention.

For example, the first workstation works at a first physical layer, and the second workstation works at a second physical layer.

For example, the terminal includes a first Wi-Fi chip, and the first Wi-Fi chip is configured to generate the first workstation and the second workstation.

For example, the terminal includes a first Wi-Fi chip and a second Wi-Fi chip, the first Wi-Fi chip is configured to generate the first workstation, and the second Wi-Fi chip is configured to generate the second workstation.

The first physical layer and the second physical layer may work on a same frequency band, or may work on different frequency bands. For example, the first physical layer works on the 2.4G frequency band, and the second physical layer works on the 5G frequency band.

For example, the terminal determines that the signal quality of the first access point meets the handover condition. The terminal performs scanning to probe around for other access points, and selects the second access point from the scanned other access points. The terminal establishes the second communication connection to the second access point by using the second workstation.

For example, the terminal may probe around for other access points in an active scanning manner or in a passive scanning manner. Scanning is a process in which a workstation of the terminal searches for a wireless network.

For example, when the terminal performs active scanning, the second workstation actively sends a probe signal, namely, a probe request (Probe Request) frame successively on a channel supported by the second workstation, to probe around for a wireless network.

For example, when the terminal performs passive scanning, the second workstation does not actively send a probe request packet, but passively receives a beacon frame periodically sent by a surrounding access point.

For example, from the scanned other access points, the terminal selects an access point with highest signal strength as the second access point.

For example, from the scanned other access points, the terminal selects a once-connected access point as the second access point.

Step 203: The terminal determines that signal quality of the second access point is better than the signal quality of the first access point, and the terminal breaks the first communication connection.

For example, that the terminal determines that signal quality of the second access point is better than the signal quality of the first access point includes: performing, by the terminal, link detection on the second communication connection and the first communication connection, and determining, based on a result of the link detection, that the signal quality of the second access point is better than the signal quality of the first access point.

For example, the signal quality of the first access point and the signal quality of the second access point are determined based on the parameter value of the link detection. For description of the parameter of the link detection, refer to the foregoing description. Details are not described herein again.

According to the wireless local area network access point handover method provided in this embodiment of the present invention, when a connection between the first workstation and a current access point is maintained, a connection to another access point is established by using the second workstation. After signal quality of the another access point is determined to be better than signal quality of the current access point, the connection between the first workstation and the current access point is broken, and the connection between the second workstation and the another access point is retained, thereby implementing a seamless handover between the terminal and an access point, and improving user experience.

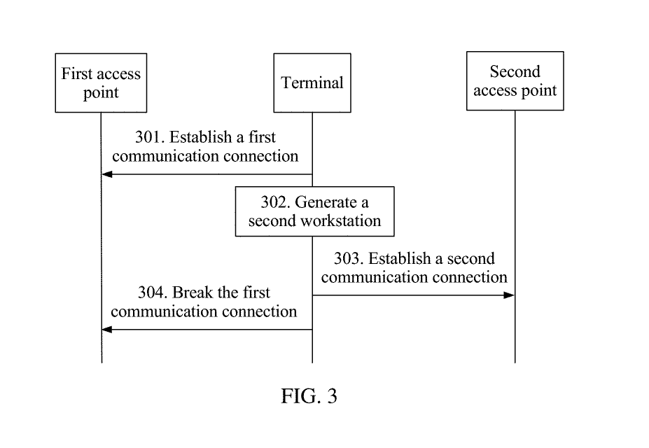

FIG. 3 is a schematic diagram of communication in another wireless local area network access point handover method according to an embodiment of the present invention. As shown in FIG. 3, this embodiment may include the following steps.

Step 301: A terminal establishes a first communication connection to a first access point by using a first workstation.

Step 302: The terminal generates a second workstation.

For example, the terminal generates a second workstation that works at a first physical layer.

For example, the terminal includes a first Wi-Fi chip, and the first Wi-Fi chip is configured to generate the first workstation and the second workstation.

For example, the terminal generates, in a time-sharing virtualization manner by using a Wi-Fi chip, the second workstation that works at the first physical layer. The first workstation also works at the first physical layer. The first workstation and the second workstation may respectively work on a first frequency band and a second frequency band in the time-sharing manner. The first frequency band and the second frequency band may be the same or may be different. For example, it is assumed that one period is 25 ms, the first workstation works on the first frequency band in a first period, the second workstation works on the second frequency band in a second period, and so on. The first frequency band and the second frequency band may be the same, and both are 2.4G frequency bands or 5G frequency bands. Alternatively, the first frequency band and the second frequency band may be different. For example, the first frequency band is a 2.4G frequency band, and the second frequency band is a 5G frequency band; or the first frequency band is a 5G frequency band, and the second frequency band is a 2.4G frequency band. For example, when the first workstation works on the first frequency in the first period, the terminal broadcasts a message to the first access point, and the message is used to notify the first access point that in the following second working period, the first workstation is to be in a dormant state. In other words, in the second working period, the terminal does not receive or send data by using the first workstation. Similarly, when the second workstation works on the second frequency in the second period, the terminal broadcasts a message to the second access point, and the message is used to notify the second access point that in the following third working period, the second workstation is to be in a dormant state. In other words, in the third working period, the terminal does not receive or send data by using the second workstation. For example, the second workstation is a proxy workstation (proxy station). For example, although the first workstation and the second workstation share a radio frequency component at the first physical layer, the two complete workstations alternate to work from a logical perspective (for example, at a link layer and a network layer).

For example, the terminal generates, through virtualization by using software, the second workstation that works at the first physical layer.

Step 303: The terminal determines that signal quality of the first access point meets a handover condition, the terminal detects a second access point, and the terminal establishes a second communication connection to the second access point by using the second workstation.

Step 304: The terminal determines that signal quality of the second access point is better than the signal quality of the first access point, and the terminal breaks the first communication connection.

It should be noted that for steps 301, 303, and 304, reference may be made to the detailed description of steps 201 to 203 in FIG. 2, and details are not described herein again.

According to the wireless local area network access point handover method provided in this embodiment of the present invention, when a connection between the first workstation and a current access point is maintained, the second workstation is generated, and a connection to another access point is established. After signal quality of the another access point is determined to be better than signal quality of the current access point, the connection between the first workstation and the current access point is broken, and the connection between the second workstation and the another access point is retained, thereby implementing a seamless handover between the terminal and an access point, and improving user experience.

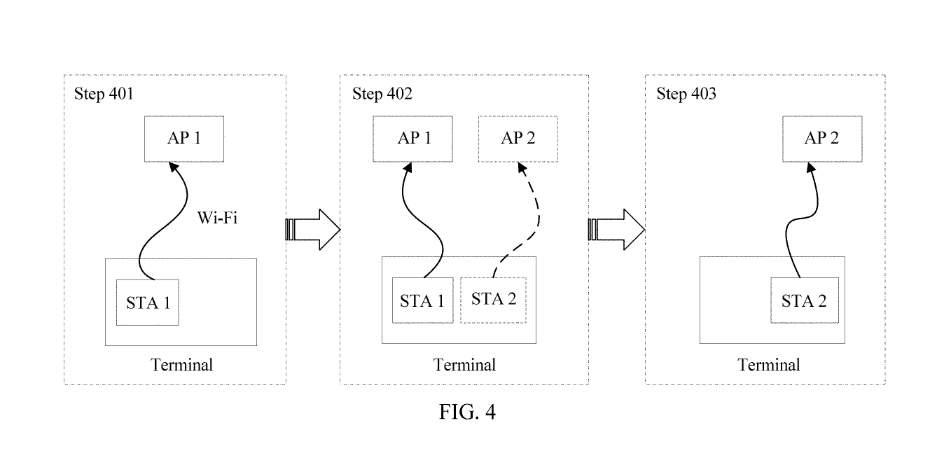

FIG. 4 is a schematic diagram of an access point handover application scenario of a terminal according to an embodiment of the present invention. As shown in FIG. 4, an access point handover performed by a terminal includes the following steps:

Step 401: A first workstation STA 1 establishes a first communication connection to a first access point AP 1 by using Wi-Fi, and a terminal periodically detects a link status of the AP 1, where a detection parameter includes factors such as received signal strength, a packet error rate, and a data transmission delay. After determining, based on a result of the detection parameter, that the link status of the AP 1 meets a handover condition, the terminal starts background scanning, and detects whether there is an AP with better signal quality.

Step 402: The terminal determines that there is a second access point AP 2 with better signal quality, and establishes, without breaking the first communication connection, a second communication connection to the AP 2 by using a second workstation STA 2.

Step 403: Perform link detection on the second communication connection, determine that a link status of the second communication connection is better than a link status of the first communication connection, break the connection between the STA 1 and the AP 1, retain the connection between the STA 2 and the AP 2, and complete a link handover.

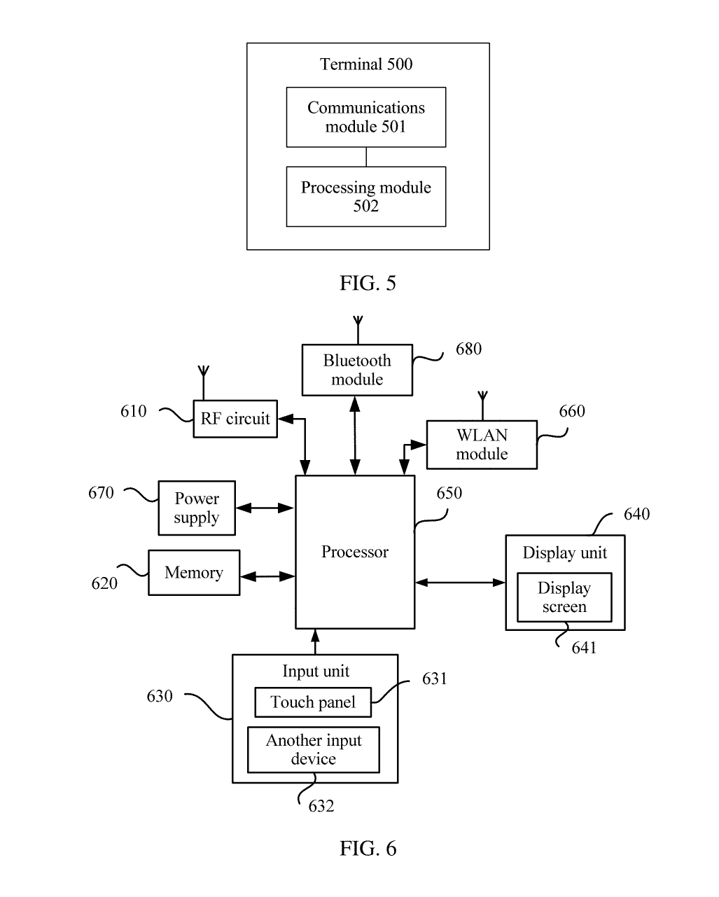

The foregoing describes in detail the wireless local area network access point handover method according to the embodiments of the present invention with reference to FIG. 1 to FIG. 4. The following describes in detail a terminal according to embodiments of the present invention with reference to FIG. 5 and FIG. 6.

FIG. 5 is a schematic structural diagram of a terminal according to an embodiment of the present invention. The terminal 500 includes a communications module 501 and a processing module 502.

A person skilled in the art may understand that FIG. 5 shows only a simplified design of a structure of the terminal. The structure of the terminal shown in FIG. 5 constitutes no limitation on the terminal. The terminal may include more or fewer components than those shown in FIG. 5. For example, the terminal may further include a storage module that is configured to store an instruction corresponding to a communications algorithm.

In FIG. 5, the processing module 502 is configured to: instruct the communications module 501 to establish a first communication connection to a first access point by using a first workstation; determine that signal quality of the first access point meets a handover condition, instruct the communications module 501 to detect a second access point and establish a second communication connection to the second access point by using a second workstation; and determine that signal quality of the second access point is better than the signal quality of the first access point, and instruct the communications module 501 to break the first communication connection.

For example, the processing module 502 is further configured to: before instructing the communications module 501 to establish the second communication connection to the second access point by using the second workstation, instruct the communications module 501 to generate the second workstation.

For example, the first workstation works at a first physical layer, and the second workstation works at a second physical layer.

For example, the terminal includes a first Wireless Fidelity Wi-Fi chip, and the first Wi-Fi chip is configured to generate the first workstation and the second workstation.

For example, the terminal includes a first Wireless Fidelity Wi-Fi chip and a second Wi-Fi chip, the first Wi-Fi chip is configured to generate a first workstation layer, and the second Wi-Fi chip is configured to generate the second workstation.

For example, that the processing module 502 determines that signal quality of the first access point meets a handover condition includes: instructing, by the processing module 502, the communications module 501 to perform link detection on the first communication connection, and determining, based on a result of the link detection, that the signal quality of the first access point meets the handover condition.

For example, that the processing module 502 determines that signal quality of the second access point is better than the signal quality of the first access point includes: instructing, by the processing module 502, the communications module 501 to perform link detection on the second communication connection, and determining, based on a result of the link detection, that the signal quality of the second access point is better than the signal quality of the first access point.

For example, a parameter of the link detection includes received signal strength, a packet error rate, and a data transmission delay.

When maintaining a connection between the first workstation and a current access point, the terminal provided in this embodiment of the present invention establishes a connection to another access point by using the second workstation. After determining that signal quality of the another access point is better than signal quality of the current access point, the terminal breaks the connection between the first workstation and the current access point, and retains the connection between the second workstation and the another access point, thereby implementing a seamless handover between the terminal and an access point, and improving user experience.

FIG. 6 is a schematic structural diagram of another terminal according to an embodiment of the present invention. As shown in FIG. 6, the terminal includes components such as a radio frequency (Radio Frequency, RF) circuit 610, a memory 620, an input unit 630, a display unit 640, a processor 650, a wireless local area network (Wireless Local Area Network, WLAN) module 660, a power supply 670, and a Bluetooth module 680. A person skilled in the art may understand that the structure of the terminal shown in FIG. to constitutes no limitation on the terminal. The terminal may include more or fewer components than those shown in the figure, and some components may be combined, or the components may be arranged in a different way.

The RF circuit 610 may be configured to receive and send information, for example, connect to mobile broadband. Usually, the RF circuit 610 includes but is not limited to an antenna, at least one amplifier, a transceiver, a coupler, a low noise amplifier (Low Noise Amplifier, LNA), a duplexer, and the like. In addition, the RF circuit 610 may further forward a mobile bandwidth service to the WLAN module 660, to forward the mobile bandwidth service to another terminal by using the WLAN module 660. Wireless communication may use any communications standard or protocol, including but not limited to: Global System for Mobile Communications (Global System of Mobile communication, GSM), a general packet radio service (General Packet Radio Service, GPRS), Code Division Multiple Access (Code Division Multiple Access, CDMA), Wideband Code Division Multiple Access (Wideband Code Division Multiple Access, WCDMA), Long Term Evolution (Long Term Evolution, LTE), an email, a short message service (Short Messaging Service, SMS), and the like.

The memory 620 may be configured to store a program instruction, and the processor 650 runs the program instruction stored in the memory 620, so that the terminal performs the wireless local area network access point handover method shown in FIG. 2 and FIG. 3. The memory 620 may mainly include a program storage area and a data storage area. The program storage area may store an operating system and an application program required for implementing the wireless local area network access point handover method. The data storage area may store list information of the terminal, data generated when the terminal performs the wireless local area network access point handover method, and the like. In addition, the memory 620 may include a volatile memory (volatile memory), such as a random-access memory (random-access memory, RAM); or the memory 620 may include a nonvolatile memory (non-volatile memory), such as a read-only memory (read-only memory, ROM), a flash memory (flash memory), a hard disk (hard disk drive, HDD), or a solid state drive (solid-state drive, SSD). Alternatively, the memory 620 may include a combination of the foregoing types of memories.

The input unit 630 may be configured to receive digit or character information entered by a user, including an instruction of enabling a WLAN hotspot, an instruction of selecting a terminal that shares the WLAN hotspot, and the like. Specifically, the input unit 630 may include a touch panel 631 and another input device 632. The touch panel 631 is also referred to as a touchscreen, and may collect a touch operation (for example, an operation performed by the user on or near the touch panel 631 by using any appropriate object or accessory such as a finger or a stylus) of the user on or near the touch panel 631, and drive a corresponding connection apparatus based on a preset program. Optionally, the touch panel 631 may include two parts: a touch detection apparatus and a touch controller. The touch detection apparatus detects a touch direction of the user, detects a signal brought by the touch operation, and transmits the signal to the touch controller. The touch controller receives touch information from the touch detection apparatus, converts the touch information into touch point coordinates, and then sends the touch point coordinates to the processor 650. The touch controller can receive and execute a command sent by the processor 650. In addition, the input unit 630 may implement the touch panel 631 by using a plurality of types, such as a resistive type, a capacitive type, an infrared ray, and a surface acoustic wave. In addition to the touch panel 631, the input unit 630 may include the another input device 632. Specifically, the another input device 632 may include but is not limited to one or more of a physical keyboard, a function key (for example, a volume control key or an on/off key), a trackball, a mouse, and a joystick.

The display unit 640 may be configured to display information entered by the user or information provided for the user, and various menus of the terminal. The display unit 640 may include a display screen 641. Optionally, the display screen 641 may be configured in a form of a liquid crystal display (Liquid Crystal Display, LCD), an organic light-emitting diode (Organic Light-Emitting Diode, OLED), or the like. Further, the touch panel 631 may cover the display screen 641. When detecting the touch operation on or near the touch panel 631, the touch panel 631 transfers the touch operation to the processor 650 to determine a type of a touch event, and then the processor 650 provides corresponding visual output on the display screen 641 based on the type of the touch event. Although the touch panel 631 and the display screen 641 are used as two independent components to implement input and input functions of the terminal in FIG. 6, the touch panel 631 and the display panel 641 may be integrated to implement the input and output functions of the terminal in some embodiments.

As a control center of the terminal, the processor 650 is connected to all components of the entire terminal by using various interfaces and lines, and performs the wireless local area network access point handover method shown in FIG. 9 by running or performing the software program and/or the module that are/is stored in the memory 620 and invoking data stored in the memory 620. Optionally, the processor 650 may include one or more processing units. Preferably, an application processor and a modem processor may be integrated into the processor 650. The application processor mainly processes an operating system, a user interface, an application program, and the like. The modem processor mainly processes wireless communication. It may be understood that the modem processor may be not integrated into the processor 650.

The WLAN module 660 may be configured to help the user receive and send an email, browse a web page, access streaming media, and the like. The WLAN module 660 provides the user with wireless broadband WLAN Internet access. A WLAN is a short-distance wireless transmission technology. The terminal may access the WLAN hotspot by using the WLAN module 660, or may enable the WLAN hotspot by using the WLAN module 660, to forward the mobile bandwidth service to another terminal. The WLAN module 660 may further perform Wi-Fi broadcast and scanning, to implement wireless communication with another surrounding terminal.

The terminal further includes the power supply 670 (for example, a battery) that supplies power to each component. Optionally, the power supply may be logically connected to the processor 650 by using a power management system, to manage functions such as charging, discharging, and power consumption by using the power management system.

The Bluetooth module 670 may be a Bluetooth low energy (Bluetooth Low Energy, BLE) device, or may be a conventional Bluetooth device, or may be a dual-mode Bluetooth device that supports conventional Bluetooth and the BLE. The Bluetooth module 670 establishes a BLE connection or a classic Bluetooth connection to a Bluetooth module of another terminal, and the Bluetooth module 670 may further perform BR or BLE broadcast and scanning, to implement wireless communication with another surrounding terminal.

Although not shown, the terminal may further include a camera, a loudspeaker, and the like, and details are not described herein.

For example, the RF circuit 610, the Bluetooth module 680, and the WLAN module 660 may be collectively referred to as a wireless communications interface.

For example, the terminal includes the processor 650, the memory 620, and the WLAN module 660. The memory 620 is configured to store the program instruction. The processor 650 is configured to perform, based on the program instruction stored in the memory 620, the following operations: instructing the WLAN module 660 to establish a first communication connection to a first access point by using a first workstation; determining that signal quality of the first access point meets a handover condition, instructing the WLAN module 660 to detect a second access point, and instructing the WLAN module 660 to establish a second communication connection to the second access point by using a second workstation; and determining that signal quality of the second access point is better than the signal quality of the first access point, and instructing the WLAN module 660 to break the first communication connection.

For example, the processor 650 is further configured to perform, based on the program instruction stored in the memory 620, the following operation: before instructing the WLAN module 660 to establish the second communication connection to the second access point by using the second workstation, instructing the WLAN module 660 to generate the second workstation.

For example, the first workstation works at a first physical layer, and the second workstation works at a second physical layer.

For example, the WLAN module 660 includes a first Wireless Fidelity Wi-Fi chip, and the first Wi-Fi chip is configured to generate the first workstation and the second workstation.

In a possible design, the WLAN module 660 includes a first Wi-Fi chip and a second Wi-Fi chip, the first Wi-Fi chip is configured to generate the first workstation, and the second Wi-Fi chip is configured to generate the second workstation.

For example, the processor 650 is specifically configured to perform, based on the program instruction stored in the memory 620, the following operations: instructing the WLAN module 660 to perform link detection on the first communication connection, and determining, based on a result of the link detection, that the signal quality of the first access point meets the handover condition.

For example, the processor 650 is specifically configured to perform, based on the program instruction stored in the memory 620, the following operations: instructing the WLAN module 660 to perform link detection on the second communication connection, and determining, based on a result of the link detection, that the signal quality of the second access point is better than the signal quality of the first access point.

For example, a parameter of the link detection includes received signal strength, a packet error rate, and a data transmission delay.

When maintaining a connection between the first workstation and a current access point, the terminal provided in this embodiment of the present invention establishes a connection to another access point by using the second workstation. After determining that signal quality of the another access point is better than signal quality of the current access point, the terminal breaks the connection between the first workstation and the current access point, and retains the connection between the second workstation and the another access point, thereby implementing a seamless handover between the terminal and an access point, and improving user experience.

Steps of methods or algorithms described in the embodiments disclosed in this specification may be implemented by hardware, a software module executed by a processor, or a combination thereof. The software module may reside in a random access memory (RAM), a memory, a read-only memory (ROM), an electrically programmable ROM, an electrically erasable programmable ROM, a register, a hard disk, a removable disk, a CD-ROM, or any other form of storage medium known in the art.

In the foregoing specific implementations, the objective, technical solutions, and benefits of the present invention are further described in detail. It should be understood that the foregoing descriptions are merely specific implementations of the present invention, but are not intended to limit the protection scope of the present invention. Any modification, equivalent replacement, or improvement made without departing from the spirit and principle of the present invention should fall within the protection scope of the present invention.

1-24. (canceled)

25. A wireless local area network access point handover method, wherein the method comprises:
establishing, by a terminal, a first communication connection to a first access point by using a first workstation;
generating, by the terminal, a second workstation;
in response to determining that signal quality of the first access point meets a handover condition, detecting, by the terminal, a second access point;
establishing, by the terminal, a second communication connection to the second access point by using the second workstation;
determining, by the terminal, that signal quality of the second access point is better than the signal quality of the first access point; and
breaking, by the terminal, the first communication connection.

26. The method according to claim 25, wherein the first workstation works at a first physical layer, and the second workstation works at a second physical layer.

27. The method according to claim 25, wherein the terminal comprises a first Wireless Fidelity Wi-Fi chip, and the first Wi-Fi chip is configured to generate the first workstation and the second workstation.

28. The method according to claim 25, wherein the terminal comprises a first Wi-Fi chip and a second Wi-Fi chip, the first Wi-Fi chip is configured to generate the first workstation, and the second Wi-Fi chip is configured to generate the second workstation.

29. The method according to claim 25, wherein the determining, by the terminal, that signal quality of the first access point meets a handover condition comprises:
performing, by the terminal, link detection on the first communication connection, and determining, based on a result of the link detection, that the signal quality of the first access point meets the handover condition.

30. The method according to claim 25, wherein the determining, by the terminal, that signal quality of the second access point is better than the signal quality of the first access point comprises:
performing, by the terminal, link detection on the second communication connection, and determining, based on a result of the link detection, that the signal quality of the second access point is better than the signal quality of the first access point.

31. The method according to claim 30, wherein a parameter of the link detection comprises received signal strength, a packet error rate, and a data transmission delay.

32. The method according to claim 25, wherein the second workstation is a proxy station.

33. The method according to claim 25, wherein the first workstation works at a first frequency, and the second workstation works at a second frequency.

34. A terminal, comprising:
at least one processor; and
a memory coupled to the at least one processor and storing programming instructions that, when executed by the at least one processor, cause the terminal to:
establish a first communication connection to a first access point by using a first workstation;
generate a second workstation;
in response to determining that signal quality of the first access point meets a handover condition, detect a second access point;
establish a second communication connection to the second access point by using the second workstation;
determine that signal quality of the second access point is better than the signal quality of the first access point; and
break the first communication connection.

35. The terminal according to claim 34, wherein the first workstation works at a first physical layer, and the second workstation works at a second physical layer.

36. The terminal according to claim 34, wherein the terminal comprises a first Wireless Fidelity Wi-Fi chip, and the first Wi-Fi chip is configured to generate the first workstation and the second workstation.

37. The terminal according to claim 34, wherein the terminal comprises a first Wi-Fi chip and a second Wi-Fi chip, the first Wi-Fi chip is configured to generate the first workstation, and the second Wi-Fi chip is configured to generate the second workstation.

38. The terminal according to claim 34, wherein the determining that signal quality of the first access point meets a handover condition comprises:
performing, by the terminal, link detection on the first communication connection, and determining, based on a result of the link detection, that the signal quality of the first access point meets the handover condition.

39. The terminal according to claim 34, wherein the determining that signal quality of the second access point is better than the signal quality of the first access point comprises:
performing, by the terminal, link detection on the second communication connection, and determining, based on a result of the link detection, that the signal quality of the second access point is better than the signal quality of the first access point.

40. The terminal according to claim 39, wherein a parameter of the link detection comprises received signal strength, a packet error rate, and a data transmission delay.

41. The terminal according to claim 34, wherein the second workstation is a proxy station.

42. The terminal according to claim 34, wherein the first workstation works at a first frequency, and the second workstation works at a second frequency.

43. A non-transitory computer-readable storage medium having computer-readable program code stored therein that, in response to execution by a processor of a terminal, cause the terminal to perform operations comprising:
establishing a first communication connection to a first access point by using a first workstation;
generating a second workstation;
in response to determining that signal quality of the first access point meets a handover condition, detecting a second access point;
establishing a second communication connection to the second access point by using the second workstation;
determining that signal quality of the second access point is better than the signal quality of the first access point; and
breaking the first communication connection.

44. The non-transitory computer-readable storage medium of claim 43, wherein the terminal comprises a first Wireless Fidelity Wi-Fi chip, and the first Wi-Fi chip is configured to generate the first workstation and the second workstation.
